(19) United States
(12) Patent Application Publication
(10) Pub. No.: US 2014/0297186 A1
(43) Pub. Date: Oct. 2, 2014

(54) Rock Classification Based on Texture and Composition

(71) Applicant: SCHLUMBERGER TECHNOLOGY CORPORATION, Sugar Land, TX (US)

(72) Inventors: Roberto Suarez-Rivera, Salt Lake City, UT (US); Ahmed Hakami, Dhahran (SA); Eric Edelman, Salt Lake City, UT (US)

(73) Assignee: Schlumberger Technology Corporation, Sugar Land, TX (US)

(21) Appl. No.: 13/855,659

(22) Filed: Apr. 2, 2013

(51) Int. Cl. G01N 31/00; G01B 21/20

(52) U.S. Cl. CPC G01N 31/00; G01B 21/20
USPC 702/2; 702/27

(57) ABSTRACT

A methodology provides improved rock classification. The rock classification may be based on characteristics such as texture and composition. Initially, data is obtained on rock in a given subterranean region. The data is processed to derive a material behavior and/or material properties in the subterranean region based on texture and/or composition of the rock.

### BACKGROUND

Rock facies classification is a way of grouping rock units that are similar or dissimilar. The rock classification facilitates description of complex systems and also facilitates their numerical modeling. Such classification also allows the development of knowledge based on comprehensive investigations and laboratory testing on a limited number of samples. However, classifications using different measurements or criteria can lead to different numbers of rock facies and it is not clear that such rock groups in the same class have common material properties within a narrow distribution range.

### SUMMARY

In general, the present disclosure provides for improved rock classification. The rock classification may be based on rock attributes of texture and composition. Initially, data is obtained on rock in a given subterranean region. The data is processed to derive a material behavior and/or material properties in the subterranean region based on texture and/or composition of the rock. The processed information is helpful in defining the geologic system.

However, many modifications are possible without materially departing from the teachings of this disclosure. Accordingly, such modifications are intended to be included within the scope of this disclosure as defined in the claims.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate only the various implementations described herein and are not meant to limit the scope of various technologies described herein, and:

FIG. 1 is a flowchart illustrating an example of a method of rock classification, according to an embodiment of the disclosure;

FIG. 2 is a schematic illustration of a processing system which may be used to process data for carrying out the rock classification methodology, according to an embodiment of the disclosure;

FIG. 3 is a flowchart illustrating another example of a method of rock classification, according to an embodiment of the disclosure;

FIG. 4 is a flowchart illustrating another example of a method of rock classification, according to an embodiment of the disclosure;

FIG. 5 is a flowchart illustrating another example of a method of rock classification, according to an embodiment of the disclosure;

FIG. 6 is a diagram illustrating results of rock classification identifying combinations of texture and composition employed to help define a geologic system, according to an embodiment of the disclosure; and

FIG. 7 is a flowchart also illustrating an example of a method of rock classification, according to an embodiment of the disclosure.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

The present disclosure generally relates to a system and methodology for performing rock classification based on rock attributes of texture and/or composition. For example, the methodology may comprise obtaining data on rock facies in a given subterranean region. The data is processed in a manner which derives material behavior and/or material properties within the subterranean region. The derived properties are based on evaluation of the texture and/or composition of the rock within the subterranean region. The knowledge and information gained can be propagated to other rocks of the same facies. In the oil industry, rock facies classification may be performed somewhat subjectively based on geologic observations, e.g. type of lithology, based on common depositional environments, or based on common time of deposition. The classification data may be obtained from core geologic studies or from regional studies on outcrops. Facies breakdown also may be performed in a more quantitative manner based on measurements, e.g. dominant X-ray diffraction (XRD) decomposition, ranges of permeability, ranges of strength, ranges of log measured gamma ray, and other measurements. The rock classification methodology described herein provides a method for further simplifying the perceived complexity into a degree of complexity that is more manageable and tractable.

In some geologic formations, rock groupings based on geologic observations of the rock facies may share the same depositional history but may not share the same mineralogy or the same post-depositional transformations and thus may not share similar current-state material properties. Similarly, groupings based on single measurements, e.g. dominant mineralogy, may have the same mineral content but with different distribution and textural arrangement, e.g. random versus laminated or compacted, thus exhibiting different material properties. When applying the methodology described herein, these concepts can be consolidated in a manner that facilitates rock class discrimination while ensuring their material properties are the same or at least fall within a narrow distribution range. Because the methodology defines and promotes rock class discrimination based on similar and dissimilar common properties, applications of the methodology comprise propagating material properties across the region of interest and populating numerical models. The methodology also may be used to improve the understanding of a geologic system and an understanding of the processes that resulted in the present distribution of material properties. The methodology enables discrimination based on texture and composition and helps explain the geologic processes that resulted in the particular combinations of texture and composition, thus adding geologic knowledge to each of the rock classes discriminated by the process.

An aspect of the present methodology is the derivation of material behavior and material properties from the geologic characteristics of texture and composition. Materials with similar texture and composition have been found to share common properties, including petrologic, geochemical, petrophysical, thermal, mechanical, optical, and other common properties. Conversely, changes in texture and composition, even when subtle, are indicative of changes in material behavior and material properties. Even small changes in texture and/or composition may indicate substantial changes in material properties. The changes may comprise changes in composition alone, while maintaining texture constant; changes in texture alone, while maintaining the composition constant; or simultaneous changes in both texture and composition. These changes in texture and/or composition are indicative of a corresponding change, and sometimes significant corresponding change, in material behavior and material properties. These changes took place because of the geologic processes of deposition and diagenesis within a unique environment and as a function of time (i.e. geology drives the process that separates the classes and is not a passive container of these classes).

For practical applications of regional scale characterization involving multiple wells, identification of texture and composition is not necessarily accomplished by conducting direct measurements of texture and composition. For example, identification of texture and composition may be accomplished using indirect continuous measurements (e.g. petrophysical well logs, seismic data, or sets of continuous measurements along the core, such as strength, thermal conductivity, thermal diffusivity, XRF elemental composition, X-ray CT, surface hardness, and/or dissolved salts) that are affected by texture and composition to facilitate evaluation of the characteristic changes in texture and composition along the region measured. The present technique enables recognition of rock classes with similar texture and composition relative to other rock classes (e.g. as defined in previous wells) based on similar combinations or patterns of indirect measurements such as, for example, log suites, seismic attributes, or continuous measurements on core.

The methodology may comprise utilization of the Heterogeneous Rock Analysis (HRA) method which employs multivariate cluster analysis statistics to define rock classes based on multiple measurements. Examples include petrophysical well logs, a set of continuous measurements on core, and a set of seismic data attributes. By increasing the number of non-redundant measurements used in the analysis and by defining patterns of these combined measurements, e.g. well log responses, the observed uniqueness of the rock classes may be considerably increased. Increasing the number of non-redundant measurements also increases the resolution of the rock classes, including rock classes separated by small but consistent changes in the log responses. It increases the confidence that the combined log patterns are real as opposed to artifacts associated with wellbore conditions or resulting from tool problems.

Heterogeneous Rock Analysis classification is based on cluster analysis statistics, or the equivalent, and uses multiple log measurements simultaneously as a basis for classification. This approach enables creation of patterns of log responses and the grouping of those responses into similar and dissimilar classes. Because the rock and its pore fluids affect the log responses, the analysis classifies rock types based on similar and dissimilar groups of log responses. The method defines rock classes based on consistent data structures, defined by pattern recognition of the measured data, using measured channels. The HRA classification is predicated on the structure of the data, not on preconceived ideas of what the data should represent. In other words, the data speaks for itself. Rock classes are defined quantitatively and non-subjectively based on high quality data. The resulting patterns have a unique meaning and, as a consequence, the rock classes become recognizable. The methodology also enables creation of classifications based on a large number of measurements, thus increasing the resolution for resolving subtle changes while simultaneously improving the confidence that the recognized patterns are real and not influenced by arbitrary effects. Examples of HRA and Heterogeneous Earth Model (HEM) methods that may be utilized in the present methodology are described in U.S. Pat. No. 8,200,465.

According to another embodiment or aspect of the disclosure, the methodology involves determining that some measurements may be affected predominantly by the rock composition, some measurements may be affected predominantly by the rock fabric or texture, and some measurements may be affected substantially by both the composition and the fabric/texture. Selection of an appropriate group of measurement techniques is helpful in defining the two drivers of texture and composition. By way of example, the measurements may be taken by a non-redundant petrophysical well log suite. In one example, a log suite comprising compositional logs, spectral gamma ray, photoelectric effect (PE), and density (RHO) can be used to strongly discriminate rocks on the basis of composition while ignoring variability associated with texture. Other well logs sensitive to texture may be added (e.g. directional sonic velocities, directional resistivity, directional nuclear magnetic resonance, high resolution near-borehole resistivity) to enable discrimination with respect to texture. These and other types of measurements and measuring systems may be employed to enable discrimination based on both texture and composition. Sometimes the logs are selected to probe texture, to probe composition, or to probe both texture and composition.

In another aspect, the methodology may be used for separating texture and composition components. Rock classification may thus be conducted based on the two components of texture and composition. The changes in texture, composition or both from rock type to rock type are then identified. Subsequently, the material properties associated with each rock class, i.e. with each combination of texture and composition detected in the system, may be defined.

The methodology described herein may be applied at several scales, e.g. core, log, or seismic scales, by multiple types of measurements, e.g. continuous measurements on core, well logs, and seismic measurements. The appropriate number and type of measurements may be selected to enable detection of the drivers of these properties, i.e. texture and composition. Given that in geologic systems these properties change with scale, the methodology enables a better understanding of these changes quantitatively, by using measurements obtained at various scales, e.g. core, log, seismic, and also enables a better understanding of the scaling relationships.

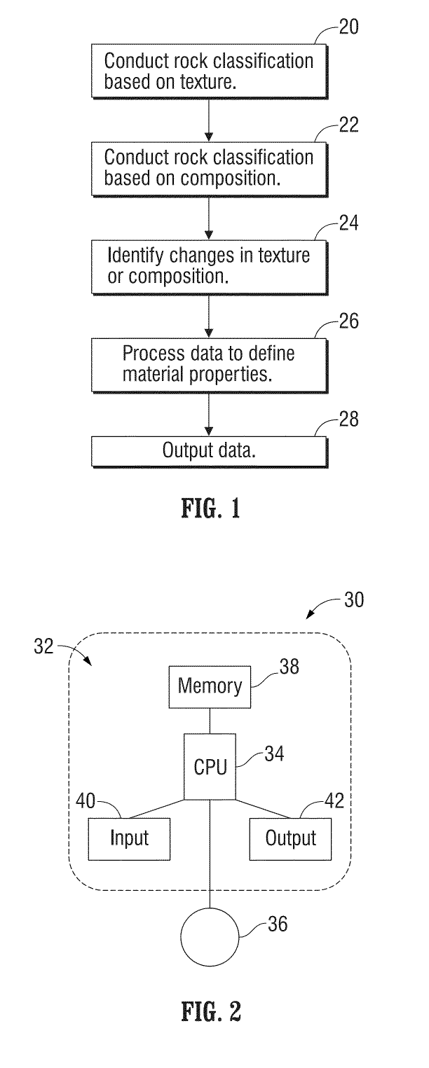

Referring generally to FIG. 1, a flowchart is provided to illustrate an embodiment of the methodology. In this embodiment, the methodology comprises conducting rock classification based on texture, as indicated by block 20. The method also comprises conducting rock classification based on composition, as indicated by block 22. Any changes in texture or composition are then identified, as indicated by block 24. The data obtained on sets of classes with distinct texture and composition is processed for sampling and characterization to define material properties related to the geologic region, as indicated by block 26. The data may then be processed into a user friendly form and output, as indicated by block 28. By way of example, the data may be output to a display screen of, for example, a computer-based system.

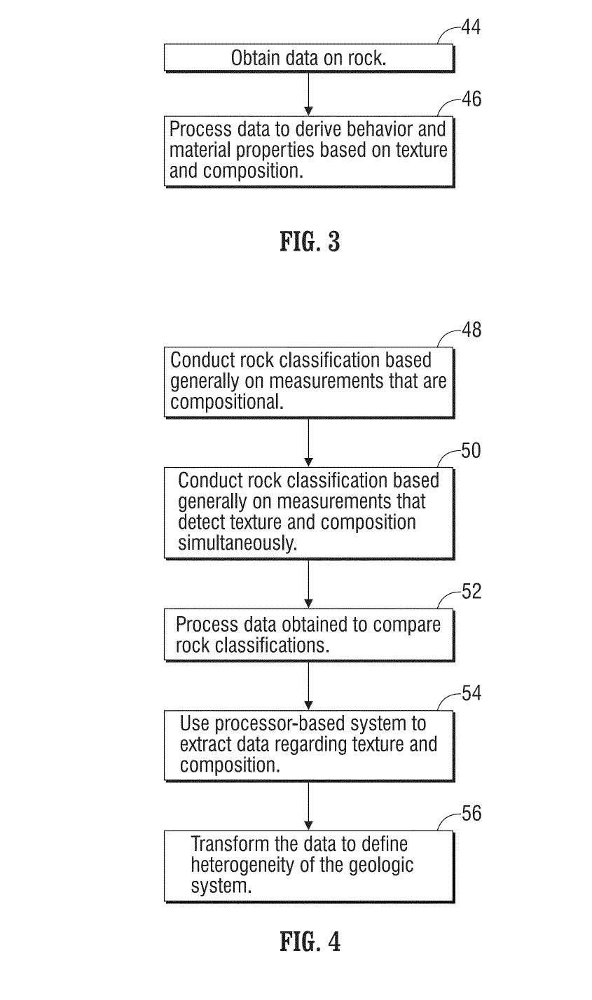

In this embodiment and other embodiments described herein, the various data collected on texture and/or composition of the rock facies may be input and processed on a processor-based system 30, as illustrated schematically in FIG. 2. Additionally, the data may be used to construct models and/or may be subjected to modeling on the processor-based system 30. By way of example, the processor-based system 30 may be employed to run HRA models and/or various other mathematical algorithms to facilitate application of the methodology described herein. Some or all of the methodology outlined with reference to FIG. 1 and also with reference to FIGS. 3-6 (described below) may be carried out by processor-based system 30. In this example, processor-based system 30 comprises an automated system 32 designed to automatically perform the desired data processing.

The processor-based system 30 may be in the form of a computer-based system having a processor 34, such as a central processing unit (CPU). The processor 34 is operatively employed to intake data, process data, and run various models/algorithms 36, e.g. classification models, HRA models and/or other types of models or algorithms related to analysis of texture and composition. The processor 34 also may be operatively coupled with a memory 38, an input device 40, and an output device 42. Input device 40 may comprise a variety of devices, such as a keyboard, mouse, voice recognition unit, touchscreen, other input devices, or combinations of such devices. Output device 42 may comprise a visual and/or audio output device, such as a computer display, monitor, or other display medium having a graphical user interface. Additionally, the processing may be done on a single device or multiple devices on location, away from the reservoir/rock location, or with some devices located on location and other devices located remotely. Once the desired modeling and other programming is constructed based on the desired texture and composition-based rock classification, the texture and composition data and the results of the analysis obtained may be stored in memory 38.

Referring generally to FIG. 3, a flowchart is provided to illustrate another embodiment of the methodology. In this embodiment, the methodology comprises obtaining data on the subject rock, as indicated by block 44, and then processing the data, as indicated by block 46. The data is processed to derive behavior and material properties. In this example, the material behavior and material properties of the rock are again fully derived from analysis of the rock attributes of texture and composition.

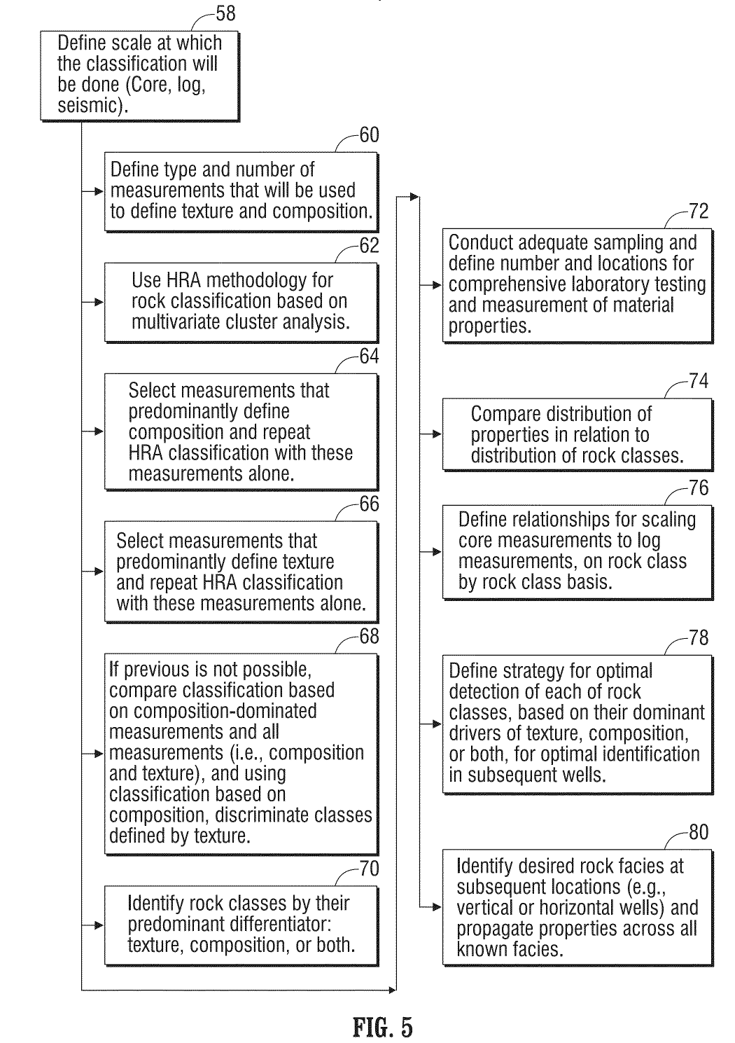

Referring generally to FIG. 4, a flowchart is again provided to illustrate another embodiment of the methodology. In this embodiment, rock classification is conducted based generally on measurements that are compositional, as indicated by block 48. Additionally, rock classification is conducted based generally on measurements that detect texture and composition simultaneously, as indicated by block 50. The data obtained is then processed, e.g. processed on processor-based system 30, to compare the rock classifications, as indicated by block 52. The processor-based system 30 is then employed to extract data regarding texture and composition, as indicated by block 54. The data is transformed to define the heterogeneity of the geologic system, as indicated by block 56, and this information may be output via, for example, output device 42. Effectively, the end product of the processes illustrated in the flowcharts discussed above is the same. In the first example, the process involved detecting individually texture and then composition, classifying each of these, and then producing output. In the second example, the process involved measuring composition, measuring texture and composition, evaluating texture by subtracting the known effect of the composition from the combined effect of texture and composition, and arriving at the same determination as the previous process. Additional elements of the processes may comprise transforming the data to define the heterogeneity of the system. That is defining the fundamental number of textural classes and compositional classes that give rise to the various rock classes (and variability and material properties) in the overall system. Elements of the processes also may comprise defining a sampling strategy and a characterization program to evaluate the material properties associated to these unique combinations of texture and composition. An additional element also may comprise populating the material properties to each of the uniquely defined rock classes in texture and composition space. The elements also may comprise providing this information in a graphical and numerical form (typically electronically using a computer platform as discussed above) and in a self-evident manner, e.g. using a unique color scheme. This end product is a HEM representation of the area studies (comprising one well or many wells or a region) and indicating the variability in rock classes (in texture and composition space) and their associated properties (quantitative and qualitative).

FIGS. 1, 3 and 4 illustrate examples as to how the detection and analysis of texture and/or composition may be used to improve an understanding of rock facies across the geologic system and thus to ultimately improve the use of a given geologic system. However, the present methodology may comprise a variety of different and/or additional elements depending on the parameters of a given environment and the goals of a particular rock classification. FIG. 5 is a flowchart representing a more detailed explanation of various aspects of the methodology. It should be noted, however, that the methodology may be adjusted, supplemented, or otherwise changed to accommodate various parameters of the classification procedure. For example, some embodiments may only use portions of the methodology described with reference to FIG. 5.

In the embodiment illustrated in FIG. 5, an initial process includes defining the scale at which the rock classification is to be performed, as indicated by block 58. For example, the classification may be performed at a core scale, a well log scale, a seismic scale, or another scale suitable for the specific environment and/or classification procedure. In this example, the type and number of measurements used to define texture and composition also are defined, as indicated by block 60. Depending on the scale selected, the ability to discriminate the two drivers, e.g. texture and composition, of material properties may affect the level of confidence placed in the measurements. For example, seismic (wave propagation) elements can be affected by both texture and composition but it may not be possible to separate the two effects. Core-scale measurements, on the other hand, provide an increased opportunity for selecting a large variety of measurements for discriminating texture and composition independently.

The methodology also may comprise using an HRA methodology to facilitate rock classification based on multivariate cluster analysis, as indicated by block 62. HRA employs principal components (PC) analysis to minimize redundancy in the measured data and to define a subset of principal component measurements that carry the maximum variability in the set of measurements. By way of example, HRA techniques are available as a service from Schlumberger Technology Corporation of Sugar Land, Tex., USA. By way of further example, the measurements that predominantly define composition may be selected, and an HRA classification may be repeated with these measurements, as indicated by block 64. The methodology also comprises selecting the measurements that are predominantly defined by texture and repeating the HRA classification with those measurements, as indicated by block 66. If the methodology indicated in block 66 is not possible or not desired, a comparison may be made between the classification based on composition dominated measurements and other measurements (i.e. based on the combined effect of texture and composition). Then, the classification based on composition and based on many other measurements may be used to discriminate classes defined by texture, as indicated by block 68. That is, sub-partitions of rock classes may be determined that are otherwise defined identically based on composition alone.

Referring again to FIG. 5, the methodology also may comprise identifying rock classes by their predominant differentiator, i.e. texture, composition, or both texture and composition, as indicated by block 70. Adequate sampling is conducted and the number and locations are defined for comprehensive laboratory testing and measurement of material properties, as indicated by block 72. Examples of such material properties include quantitative and qualitative evaluation of geology, petrology, mineralogy, geochemical, organic, petrophysical, mechanical, thermal, and other suitable material properties. These material properties may have a reasonable amount of redundancy to ensure validation of the analysis. The distribution of material properties is then compared in relation to the distribution of rock classes, as indicated by block 74. The comparison validates that the range of property distribution within a given rock class is considerably narrower than the range of the property distribution for all rock classes.

The methodology may further comprise defining relationships for scaling core measurements to log measurements on a rock class by rock class basis, as indicated by block 76. The methodology comprises defining rock physics models based on the rock class by rock class basis and on the scale by scale basis (core, log, seismic) of the measured properties in the continuous measurements used for classification. The relationships may include geologic upscaling (e.g. sequences measured at high resolution become units at a reduced resolution); measurements obtained at multiple scales (core, log, seismic); consistent classifications based on texture and composition which, in turn, are based on data obtained at different scales; and the integration of these to obtain a scaling up relationship which is consistent with the geology, with the measurements, and with the classification. Additionally, the methodology may comprise defining a strategy for optimal detection of each of the rock classes based on their dominant drivers of texture, composition, or both texture and composition for optimal identification in subsequent wells, as indicated by block 78. This strategy helps define the minimum amount of measurements (e.g. well logs) desired for identifying specific rock classes. For example, if the rock class of interest is predominantly identifiable by changes in composition, the minimum measurement requirements are compositionally driven. In some applications, the identification may be made with a certain level of confidence with a component gamma ray measurement or with higher confidence using a better compositional measurement. In this situation, however, adding strongly texturally driven tools may not be of substantial benefit. Similarly, if the rock class of interest is predominantly identifiable by changes in texture, the minimum measurement requirements tend to be texture driven. In this latter example, running compositional tools downhole into the subterranean environment may not be of substantial benefit. Regardless of whether the rock class of interest is predominantly identifiable by changes in composition, texture, or both, the desired rock facies at subsequent locations are identifiable, and the methodology facilitates propagation of those material properties across the known rock facies, as indicated by block 80.

As discussed herein, the present methodology simplifies and rationalizes a decision strategy regarding measurements for subsequent wells. Initially, a reference HRA model with a complete and comprehensive set of measurements, e.g. petrophysical well logs, may be performed. However, the present methodology further enables a cost-effective and confidence-effective selection of subsequent measurements, e.g. logs, that can be used to identify important rock facies across a region of interest in, for example, both vertical and horizontal wells. The present methodology also may be used to propagate measured properties across that region along with any knowledge and experience gained through the analysis of texture and composition.

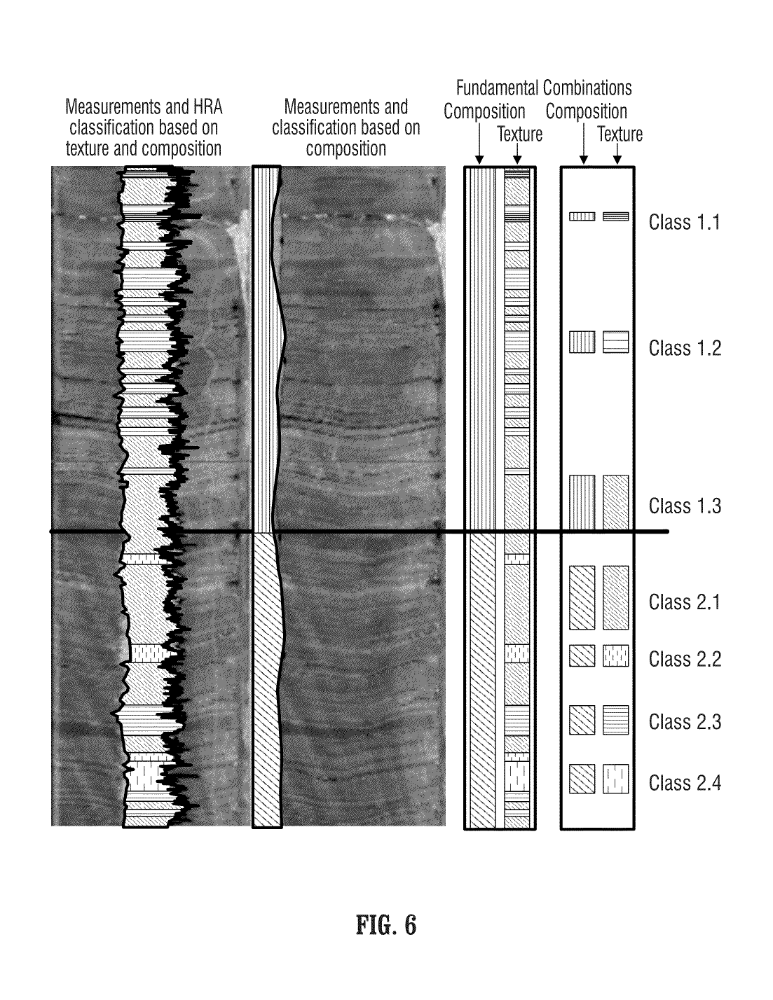

Referring generally to FIG. 6, a graphical illustration is provided of core-based rock classification or core-HRA. In this example, rock classification based on measurements that reflect texture and composition (e.g. measurements obtained via thermal conductivity and unconfined compressive strength) is illustrated on the left side of the graphical illustration. Rock classification based on measurements that reflect composition alone (e.g. measurements obtained via X-ray fluorescence (XRF) mineralogy and identification of basic elements) is illustrated in the middle of the graphical illustration. By separating units with identical composition but varying texture, an identification may be made of the fundamental combinations of texture and composition that define the system, as illustrated on the right side of the graphical illustration. In general, the process may involve working with measurements of acoustic wave propagation, thermal conductivity, thermal diffusivity, unconfined compression strength and Brinell hardness for composition and XRF mineralogy, total organic carbon, hydrocarbon composition and computed tomography (CT) scan density for compression, and/or other measurements

In this particular example, FIG. 6 provides an example of at least a portion of the methodology illustrated in FIG. 5, e.g. blocks 64-70. The graphical illustration shows results that identify the fundamental combinations of texture and composition that define the geologic system of interest. In this example, two compositional groups of rock classes can be identified by the composition measurements. Similarly, five groups with similar combined texture and composition can be identified by the combined measurements. Three of the classes (1.1, 1.2 and 1.3 indicated along the right side of the graphical illustration) have similar composition in varying textures, resulting in three fundamental units that as a group can be differentiated with compositional measurements. However, their individual identification involves textural measurements. Similarly, the four rock classes labeled 2.1, 2.2, 2.3, and 2.4 also can be identified as a group with compositional measurements. Again, however, their individual identification involves textural measurements. It should be noted that identification of rock classes based on texture alone also is possible. For example, classes 1.3 and 2.1 and also classes 1.2 and 2.3 share the same texture but differ in composition in this example.

Generally, the methodology described herein provides a way of ascertaining and evaluating the two primary drivers of rock properties, i.e. texture and composition, via continuous measurements. By defining rock classes based on texture and composition, the methodology enables assessment of the equivalents in material behavior and in associated properties, e.g. reservoir, mechanical, acoustic, thermal, geochemical, and other associated properties. Thus, rock classes with similar texture and composition have similar material properties.

Also, evaluating, e.g. measuring, changes in rock texture and composition, even when the changes are subtle, enables accurate inference of changes in material behavior and material properties through the geologic system. Selection of a suitable group or suite of measurements for characterization is very helpful in defining texture and composition. Examples of groups or suites of measurements include a petrophysical well log suite, a selected set of continuous measurements along the length of the core, or attributes of seismic data.

Changes in rock behavior, e.g. defining different rock classes, can result from changes in composition alone, while maintaining texture constant; changes in texture alone, while maintaining the composition constant; or simultaneous changes in both texture and composition. In each of these examples, the result is a corresponding change (and often a significant change) in material behavior and material properties. In some environments, selecting rock classes or identifying similarity between rocks and rock classes based on composition alone is not sufficient. It should be noted that some indirect continuous measurements, e.g. a selected set of well logs or a selected set of continuous measurements on core, are affected more predominantly by rock composition while other indirect continuous measurements are affected more predominantly by the rock fabric/texture. In many environments, the indirect continuous measurements are affected by both composition and texture.

For example, a group of indirect continuous measurements that is predominantly compositional may be used to discriminate rocks on the basis of composition but may fail to fully capture their variability associated with changes in texture and vice versa. The present methodology, however, enables separating texture and composition using selected groups of indirect continuous measurements. This separation is accomplished by first conducting rock classification based on measurements that are predominantly compositional. Examples of such measurement techniques include XRD mineralogy, XRF mineralogy, component gamma ray, photoelectric log, mineralogy log, and other suitable measurement techniques. A separate rock classification is then conducted based on measurements that detect both texture and composition simultaneously. Examples of these measurement techniques include wave velocity, thermal conductivity, rock strength, resistivity, and other suitable measurement techniques. By comparing the two classifications the two fundamental components of texture and composition can be extracted by suitable processing on, for example, processor-based system 30. The processing/comparison also may be used to identify the fundamental combinations of texture and composition defining the heterogeneity of the geologic system.

Once the rock classes are defined on the basis of their fundamental texture and composition attributes, the types of measurements desired to identify these attributes in other wells may be recommended. For example, if a best reservoir quality section is differentiated from other rock classes primarily based on composition (i.e. changes in texture are secondary), the measurements for identifying this rock class in other regions of the reservoir are determined to be predominantly compositional, and vice versa. Additionally, the degree of certainty in identifying this rock class can be changed by adjusting the number and type of the measurements. For example, a specialized high reliability compositional log may be used to replace a gamma ray log.

Furthermore, the methodology accounts for the texture and composition attributes scaling differently. For example, composition may be scale independent while texture may be substantially scale dependent. By identifying and separating the two attributes, solutions to the scaling problem are facilitated to enhance the overall rock classification methodology for a given geologic system.

The results of the rock classification analysis may be output to, for example, output device 42, in numerous forms and with a variety of content. Effectively, the processor-based system 30 may be used to transform composition and/or texture data into a useful form to facilitate application of the data and of the knowledge gained to other regions of the geologic system. However, a variety of models and algorithms may be programmed into processor-based system 30 to carry out the methodology or aspects of the methodology described herein. Furthermore, examples of numerous types of measurement systems have been described herein and those measurement systems may be coupled with processor-based system 30 to enable automated processing of data during the classification procedure utilizing composition and/or texture.

The processes also may be applied to quantitative geology. When applied to core measurements, the concept of defining rock classes based on their fundamental combinations of texture and composition allow one to relate these to the geologic processes causing these changes and to the geologic facies. This concept significantly improves the traditional geologic core description method and is especially useful and efficient for characterization of heterogeneous rocks. To prevent bias in the analysis, initially two analyses are conducted (geologic core description and discrimination of rock classes) separately and then the two independent results are evaluated to find common ground. For efficiency, the sections of the core to be analyzed with detailed core geologic description may be selected based on the identification of the rock classes. That is, by understanding that these rock classes are redundant and that by analyzing one of few sections of each particular rock class, in detail, an understanding is gained of other sections from the same rock class.

Given that conducting continuous measurements is fast and that detailed geologic core characterization is a time-consuming process, the efficiency of the process is significantly improved by selecting a representative subset of core sections for detailed geologic core description and validating one's understanding based on a few randomly selected core sections representing the same rock classes. The method relates the rock classes and their thickness and cyclic stacking patterns with quantitative information of the depositional system and its sequence patterns. The method also enables differentiation between transitional and abrupt contacts and provides important information for developing the geologic model. Results enable definition of the geologic system more quantitatively and also allow understanding of the variability represented by larger samples via the relationship with their geologic context.

Traditional geologic core description can provide key sedimentologic information, such as textural and compositional features related to depositional conditions, and general diagenetic changes. Diagenesis often is very pronounced in shales and can transform the petrophysical and reservoir properties of these rocks, thus masking most of the original depositional features. Detailed, high-resolution, petrographic examination of shale samples, at microscopic (thin section) and submicroscopic scanning electron microscope (SEM) scales, provides relevant information on both the depositional and diagenetic processes. This includes the effect of fabric alignment with anisotropic material behavior or directional property (e.g. permeability, elasticity, thermal conductivity). Such studies can facilitate an understanding of the matrix dominant textural and compositional drivers of reservoir quality in the various rock units present in a region. Integrating the studies of rock classifications (based on texture and composition) also enables development of a clear relationship between the geologic processes and present-day visual geologic facies discrimination and their associated material properties. This allows the provision of a quantitative foundation to the traditional descriptive geologic analysis.

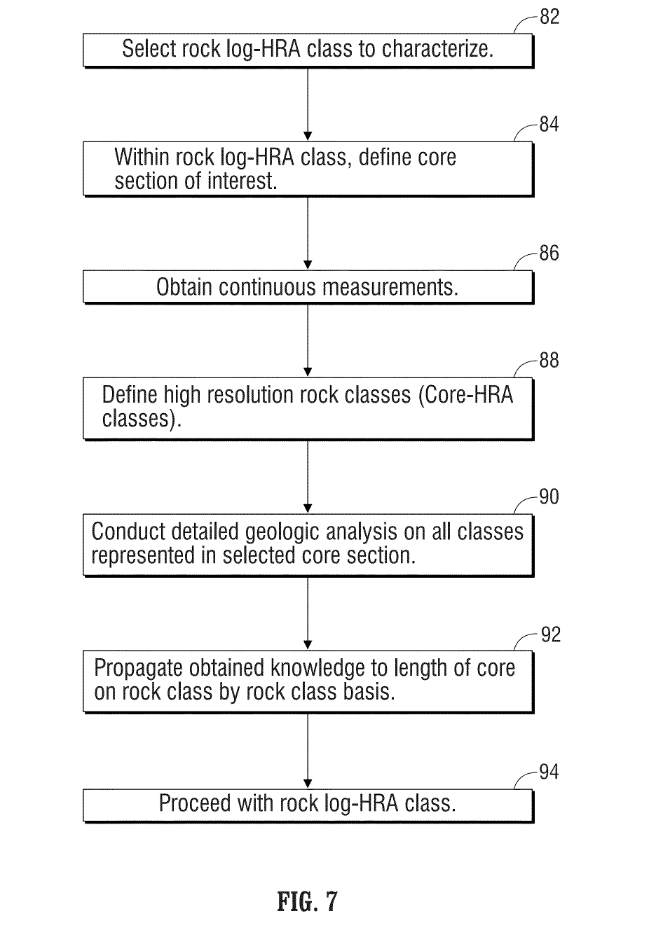

Various applications described herein may utilize or incorporate a process as outlined in the flowchart of FIG. 7. In this process example, the rock log-HRA class to be characterized is initially selected, as indicated by block 82. Within that rock log-HRA class, the core section of interest is then defined, as indicated by block 84. Continuous measurements are obtained, as indicated by block 86. Additionally, high resolution rock classes (core-HRA classes) are defined as indicated by block 88. A detailed geologic analysis is then conducted over the classes represented in the selected core section, as indicated by block 90. The obtained knowledge is propagated to the length of the core on a rock class by rock class basis, as indicated by block 92. Subsequently, the process proceeds with the next rock log-HRA class, as indicated by block 94. As discussed herein, a variety of other and/or additional elements may be incorporated into the methodology for a given application.

The rock classification techniques may be used in a variety of applications, as described herein. In additional examples, the methodology may be used for selecting representative core sections for detailed geologic core description based on core-HRA classification conducted along the length of the core. The core sections are selected to represent at least each of the individual rock classes with distinct texture and composition properties. The methodology also may be applied for integrating standard detailed geologic core description (including detailed petrology and mineralogy) with continuous measurements of multiple properties and core-HRA classification based on these properties. The methodology also may comprise defining the texture and composition defined by each of the rock classes to their geologic context including depositional origin and diagenetic transformations, the depositional environment, and time. The methodology also may be employed for providing quantitative geologic definitions to each of the geologic facies defined at the millimeter scale.

Generally, the methodology described herein may be used to define rock classes based on consistent data structures defined by pattern recognition of the measured data using multiple channels. The heterogeneous rock analysis classification is predicated on the structure of the data, not on pre-conceived ideas of what the data should represent. The data is allowed to speak for itself so that rock classes are defined quantitatively and non-subjectively based on high quality data. The resulting patterns have a unique meaning and, as a consequence, the rock classes become recognizable.

One of the differences between the methodology described herein and previous methodologies is that instead of using well log data for conducting the HRA classification, the present methodology is able to utilize high resolution core log data. This approach utilizes continuous measurements along the length of the core as opposed to standard depth specific measurements. The present methodology also provides significantly greater control and versatility with respect to the type of measurements that can be used. Material properties are defined by the fundamental material characteristics of texture and composition. Additionally, measurements on the rock (at log scale or core scale) are affected by the two fundamental material properties of texture and composition. With this methodology, one is able to select the type of measurements used on the core (or in the wellbore) to highlight specifically the material composition. In rocks, this is usually defined by the mineral composition, organic composition, and the pore-fluid composition. In some applications, the type of measurements used on the core (or in the wellbore) can be selected to highlight specifically the texture. A roundabout way to accomplish this is to understand that in general all measurements are affected by both texture and composition. Thus, for practical purposes of implementation it is possible to select specific measurements that highlight composition alone and a larger set of measurements that provide the combined effect or texture and composition.

For example, if XRD mineralogy is used as a measurement, it is possible to detect exclusively mineral composition. If, however, acoustic wave propagation or thermal conductivity is used, these measurements are affected by both texture and composition which allows for detection of the combined effect of texture and composition on these properties. This permits discrimination of the two effects by superposition and permits discrimination of the effect of texture alone. The methodology provides a direct link between classification and the fundamental material texture and composition properties via a selected set of measurements which enables detection of these properties. The methodology may be applied to measurement logs, seismic data, and others and is not restricted to core. In many applications, however, it is useful to apply core measurements because of the flexibility in the choice of measurements. As more log measurements are developed and more seismic attributes defined, the concept and methodology may be implemented for log and seismic measurements (or other well-scale and regional-scale measurements).

The classification methodology is based on measurements without a priory information, knowledge, or experience. Elements of information and field experience may be added after the model is created instead of during the creation of the model. Additionally, the sampling strategy and characterization program is based on the classification instead of the other way around. With the present methodology, classification may be based on the most common field measurements and then information may be generated as to how these uniquely identifiable rock classes represent the fundamental texture and composition properties of the rock. It has been determined that the methodology may comprise classifying based on common field measurements and then providing information on how these uniquely identifiable rock classes represent the fundamental texture and composition properties of the rock and, via these, determining a relationship with other measured properties on core (e.g. porosity, permeability, strength, and other properties).

Although only a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A method for classifying rock facies in subterranean regions, comprising:
conducting rock classification in a subterranean region based on texture;
further conducting rock classification in the subterranean region based on composition;
identifying any changes in texture or composition from rock type to rock type;
processing data on the texture and composition and on any changes in the texture and composition in the subterranean region to define material properties associated with combinations of texture and composition in the subterranean region; and
outputting data on the material properties to a display screen for use in identifying a desired rock facies at subsequent locations.

2. The method as recited in claim 1, wherein conducting rock classification based on texture comprises utilizing heterogeneous rock analysis (HRA).

3. The method as recited in claim 2, wherein conducting rock classification based on composition comprises utilizing HRA.

4. The method as recited in claim 1, further comprising selecting a group of measurements to determine texture.

5. The method as recited in claim 1, further comprising selecting a group of measurements to determine composition.

6. The method as recited in claim 1, further comprising defining the scale at which the rock classification is performed.

7. The method as recited in claim 1, further comprising defining relationships for scaling core measurements to log measurements.

8. The method as recited in claim 1, wherein processing data on the texture and composition comprises assessing similarity of material behavior and its associated properties on a rock class by rock class basis.

9. The method as recited in claim 1, further comprising using the data to determine the type of measurements needed to identify rock classes at the subsequent locations.

10. A method of rock classification, comprising:
conducting rock classification based on measurements that are predominantly compositional;
conducting rock classification based on measurements that detect both texture and composition simultaneously;
processing data obtained to compare the rock classification based on measurements that are predominantly compositional with the rock classification based on measurements that detect both texture and composition simultaneously;
using a processor-based system to extract data regarding the two components of texture and composition; and
transforming the data to identify and output combinations of texture and composition that define the heterogeneity of a geologic system.

11. The method as recited in claim 10, wherein conducting rock classification based on texture comprises utilizing HRA.

12. The method as recited in claim 10, wherein conducting rock classification based on composition comprises utilizing HRA.

13. The method as recited in claim 10, wherein after identifying combinations of texture and composition that define the heterogeneity of the geologic system, determining measurements needed to identify combinations of texture and composition in other geologic systems.

14. The method as recited in claim 10, further comprising using the data to determine appropriate scaling for both texture and composition.

15. The method as recited in claim 10, wherein using a processor-based system to extract data regarding the two components of texture and composition comprises inferring changes in material behavior and material properties.

16. The method as recited in claim 10, further comprising employing the data to define relationships for scaling core measurements to log measurements.

17. A method, comprising:
obtaining data on rock in a subterranean region; and
processing the data to derive a material behavior and material properties in the subterranean region based on texture and composition of the rock.

18. The method as recited in claim 17, wherein obtaining data on the rock comprises obtaining data from a plurality of measurement systems selected to detect texture and composition.

19. The method as recited in claim 17, further comprising transforming the data to a form that may be output to a display for review.

20. The method as recited in claim 17, further comprising using the data to identify desired rock facies at other subterranean regions.
